(19) United States
(12) Patent Application Publication
(10) Pub. No.: US 2004/0000735 A1
(43) Pub. Date: Jan. 1, 2004

(54) Partially expanded, free flowing, acid treated graphite flake

(75) Inventors: Michael H. Gilbert SR., North Olmsted, OH (US); Robert A. Reynolds III, Bay Village, OH (US); Ronald A. Greinke, Medina, OH (US)

Correspondence Address: GRAFTECH INC., Patent Law Department, 1521 Concord Pike, Suite 301, Brandywine West Building, Wilmington, DE, 19803, US

(73) Assignee: Graftech Inc.

(21) Appl. No.: 10/185,088

(22) Filed: Jun. 28, 2002

(51) Int. Cl. B29C 31/00

(52) U.S. Cl. 264/40.1; 264/319

(57) ABSTRACT

Partially expanded graphite flake having a specific volume of no more than about 50 cm³/g, more preferably, about 10-25 cm³/g has excellent sheet forming properties and is readily moldable to form molded products, such as gaskets. The partially expanded graphite flake may be produced by a low temperature process, in which the flakes are first intercalated with an intercalation solution, then subjected to a low temperature exfoliation of below about 500° C. In an alternative process, the flakes are intercalated with no more than about 40 pph of an intercalation solution (less if the particles are not subjected to a subsequent washing step) and then exfoliated at conventional exfoliation temperatures of about 800° C.

### BACKGROUND OF THE INVENTION

1. Field of the Invention

The invention relates to a graphite flake which is partially expanded. It finds particular application as a material for forming molded gaskets and graphite sheet material, although it is to be appreciated that other applications for the graphite flake material are also contemplated.

2. Discussion of the Art

Graphite is a crystalline form of carbon comprising atoms bonded in flat, layered planes with weaker bonds between the planes. By treating particles of graphite, such as natural graphite flake, with an intercalant of, e.g., a solution of sulfuric and nitric acids, the crystal structure of the graphite reacts to form a compound of graphite and the intercalant. The treated particles of graphite are hereafter referred to as intercalated graphite flake. Upon exposure to elevated temperatures of from about 600-900° C., the particles of intercalated graphite expand in dimension in an accordion-like fashion.

The graphite layer planes are formed from hexagonal arrays or networks of carbon atoms. These layer planes of hexagonally arranged carbon atoms are substantially flat and are oriented or ordered so as to be substantially parallel and equidistant to one another. The substantially flat, parallel equidistant sheets or layers of carbon atoms, usually referred to as graphene layers or basal planes, are linked or bonded together and groups thereof are arranged in crystallites. Highly ordered graphites consist of crystallites of considerable size: the crystallites being highly aligned or oriented with respect to each other and having well ordered carbon layers. In other words, highly ordered graphites have a high degree of preferred crystallite orientation. It should be noted that graphites possess anisotropic structures and thus exhibit or possess many properties that are highly directional e.g., thermal and electrical conductivity and fluid diffusion.

In considering the graphite structure, two axes or directions are usually noted, namely, the “c” axis or direction and the “a” axes or directions. For simplicity, the “c” axis or direction may be considered as the direction perpendicular to the carbon layers. The “a” axis or direction may be considered as the direction parallel to the carbon layers or the direction perpendicular to the “c” direction. The graphites suitable for manufacturing flexible graphite sheets possess a very high degree of orientation.

The bonding forces holding the parallel layers of carbon atoms together are only weak van der Waals forces. Natural graphites can be treated so that the spacing between the superposed carbon layers or laminae can be appreciably opened up so as to provide a marked expansion in the direction perpendicular to the layers, that is, in the “c” direction, and thus form an expanded or intumesced graphite structure in which the laminar character of the carbon layers is substantially retained.

Graphite flake currently manufactured by intercalation is expanded so as to have a final thickness or “c” direction dimension which is as much as about 80 or more times the original “c” direction dimension. For example, graphite flake which has been treated with an excess of an intercalant comprising a mixture of sulfuric acid and nitric acid, washed, and then exposed to a temperature of 800° C. has a specific density or expansion volume of about 200-300 cubic centimeters per gram (cm³/g). When treated with an expansion aid, such as an alcohol, the expansion volume is generally much higher, typically 500-900 cm³/g when exposed to 800° C.

The exfoliated graphite particles are vermiform in appearance, and are therefore commonly referred to as worms. The worms may be compressed together into flexible or integrated sheets of expanded graphite, e.g., webs, papers, strips, tapes, foils, mats or the like, typically referred to as “flexible graphite,” without the need for a binder. Unlike the original graphite flakes, the sheets can be formed and cut into various shapes and provided with small transverse openings by deforming mechanical impact. The density and thickness of the sheet material can be varied by controlling the degree of compression. The density of the sheet material is generally within the range of from about 0.04 g/cm³ to about 2.0 g/cm³.

In addition to flexibility, the sheet material, as noted above, has also been found to possess a high degree of anisotropy with respect to thermal and electrical conductivity and fluid diffusion, comparable to the natural graphite starting material due to orientation of the expanded graphite particles and graphite layers substantially parallel to the opposed faces of the sheet resulting from very high compression, e.g., roll pressing. Sheet material thus produced has excellent flexibility, good strength and a very high degree of orientation.

However, the highly expanded worms are generally not free flowing and tend to agglomerate, forming clumps that are difficult to transport. If clumps of agglomerated particles enter the sheet forming apparatus, variations in sheet thickness or density tend to occur.

Due to the large volume of the expanded graphite flake, the process of forming the materials into sheet products is generally carried out at or in close proximity to the intercalation plant, so that the graphite flake material does not need to be shipped large distances. Where shaped articles, such as gaskets, are desired, these are subsequently stamped from the sheet product. Due to the shapes of these items, there is a considerable amount of wastage or “drop out” from the sheet. The large volume of the expanded flake prevents direct molding of the gaskets or other products directly from the flake.

The present invention provides a new and improved graphite flake material and method of use, which overcomes the above-referenced problems, and others.

### SUMMARY OF THE INVENTION

In accordance with one aspect of the present invention, a method of forming a partially expanded graphite flake material is provided. The method includes adding an amount of a liquid intercalation solution to graphite flakes. The liquid intercalation solution includes one or more members of the group consisting of nitric acid, sulfuric acid, acetic acid, formic acid, potassium chlorate, chromic acid, potassium permanganate, potassium chromate, potassium dichromate, perchloric acid, hydrogen peroxide, iodic acids, periodic acids, ferric chloride, and halides. The intercalation solution is dispersed through the graphite flakes to produce intercalated graphite flakes. The intercalated graphite flakes are exfoliated to produce the partially expanded graphite flake material having a low volume of no more than about 50 cm³/g. The low volume being achieved by controlling at least one of the temperature of exfoliation and the amount of the liquid intercalation solution.

In accordance with another embodiment of the present invention, a method of forming a partially expanded graphite flake material is provided. The method includes adding a liquid intercalation solution to graphite flakes, the liquid intercalation solution being substantially free of expansion aids and reducing agents and dispersing the intercalation solution through the intercalated graphite flakes to produce intercalated graphite flakes. The intercalated graphite flakes are exfoliated at a temperature of from about 200° C. to about 400° C. to produce the partially expanded graphite flake material which has a volume greater than that of the original graphite flakes.

In accordance with another embodiment of the present invention, a method of forming a partially expanded graphite flake material is provided. The method includes adding a liquid intercalation solution to graphite flakes, the liquid intercalation solution being substantially free of expansion aids and reducing agents and dispersing the intercalation solution through the intercalated graphite flakes to produce intercalated graphite flakes. Optionally, the intercalated graphite flakes are washed. The intercalated graphite flakes are exfoliated to produce the partially expanded graphite flake material which has a volume greater than that of the original graphite flakes. When the step of washing the intercalated graphite flakes is omitted, the liquid intercalation solution is added to the graphite flakes in an amount of 3-10 parts by weight of solution per 100 parts by weight of the graphite flakes. When the step of washing the intercalated graphite flakes is included, the liquid intercalation solution is added to the graphite flakes in an amount of about 10-35 parts by weight of solution per 100 parts by weight of the graphite flakes.

In accordance with another embodiment of the present invention, a method of forming a molded product is provided. The method includes intercalating graphite flake with an intercalation solution. The intercalated graphite flake is exfoliated to produce an exfoliated graphite flake having a volume which is greater than that of the original graphite flake and which is less than about 50 cm³/g. The exfoliated flake is introduced into a mold and compressed to form the molded product.

An advantage of at least one embodiment of the present invention is a partially expanded graphite material which has sheet forming properties comparable to fully expanded graphite particles.

An advantage of at least one embodiment of the present invention derives from the ability to mold the partially expanded graphite material to form complex shapes, such as gaskets.

Still further advantages of the present invention will be readily apparent to those skilled in the art, upon a reading of the following disclosure.

### DETAILED DESCRIPTION OF THE PREFERRED EMBODIMENT

A partially expanded graphite flake having excellent sheet forming and molding characteristics has a density which is substantially less than that produced in conventional intercalation processes. By “partially expanded,” it is meant that the flakes have a specific volume, expressed in cm³/g, which is higher than that of the graphite from which it is formed, but only about 20%, or less, of the density of a typical expanded graphite flake. Preferably, the expanded graphite flake has a volume of no more than 100 cm³/g, more preferably, less than about 50 g/cm³, and most preferably, in the range of about 4-40 cm³/g. The partially expanded graphite flake may be formed into sheet materials for stamping out gaskets, thermal conductors, and the like, or molded directly into a shaped product.

Where volume values are given in cm³/g herein, these are measured by taking a known weight of the material and pouring it into a graduated vessel, such as a measuring cylinder, without mechanically compressing the material. The volume measured thus includes voids between and within the particles.

There are several methods for forming the partially expanded graphite. A first method, which will be described as the “low temperature method,” includes treating particles of graphite, such as natural graphite flake, with an intercalant of, e.g., a solution of sulfuric and nitric acids. The graphite reacts to form a compound of graphite and the intercalant. The intercalated graphite flake is subsequently exposed briefly to a temperature which is substantially lower than that conventionally used for expanding the intercalated flake but yet is sufficient for expansion to occur. The particles of intercalated graphite expand in dimension in an accordion-like fashion to form a partially expanded graphite flake. Intercalated flake has a furnace temperature below which expansion does not tend to occur, or occurs so slowly that the acid solution tends to diffuse out of the graphite without causing exfoliation. This temperature, termed the “intumescent temperature” varies, to some extent, depending on the composition of the intercalation solution, the size and type of the flakes, and other factors. However, by taking these factors into consideration when selecting the exfoliation temperature, a degree of expansion within the desired range can be achieved. In one embodiment, the flakes are placed in a furnace which has been heated to between about 200° C. and about 500° C.

At such temperatures, exfoliation proceeds relatively slowly. For example, at 400-500° C., a residence time of about twenty to thirty minutes is appropriate for exfoliation of graphite particles which have been intercalated with acid, washed, and dried prior to placing in the furnace.

A second method, which will be referred to herein as the “non-stoichiometric method” uses less intercalant than would conventionally be used for forming fully expanded flake. For example, conventional intercalation processes may use about 100 parts by weight of acid intercalant per 100 parts by weight of graphite (pph) when the intercalant is a mixture of 10% nitric acid (67% solution) and 90% sulfuric acid (93% solution) and a water wash is used between the intercalation and exfoliation steps. In the present method, the amount of intercalant is reduced by a factor of at least two. Preferably, when a subsequent washing step is used, no more than about 40 parts of intercalant are used with 100 parts by weight of graphite (40 pph), more preferably, less than 20 pph. Useful partially expanded graphites can be formed when the ratio is only about 10 parts of intercalant to 100 parts by weight of graphite flake. When the subsequent washing step is eliminated, the amount of intercalant can be reduced still further, and is preferably no greater than 10 pph, more preferably, about 3-8 pph.

The intercalated graphite is subsequently exfoliated by heating to above the intumescent temperature. For example, the intercalated flake may be placed in a furnace which has been heated to a temperature above 600° C., such as 700° C.-900° C. to form the partially expanded flake. It should be appreciated that in the short time that the flakes are in the furnace (typically only a few seconds for the stoichiometric process), the interior of the flake does not generally reach the furnace temperature. Thus, the temperature of the furnace is invariably slightly higher than that reached by the interior of the flake.

It should be appreciated that the exfoliation volume is not necessarily directly proportional to the level of intercalation. The amount of intercalant to be used to achieve a desired level of exfoliation also depends, to some extent, on whether a washing step is carried out between the intercalation and exfoliation steps. Where an intermediate washing step is used, the weight of intercalant required to achieve a selected degree of exfoliation tends to be higher than where the washing step is omitted. For example, if the intercalated flake is exfoliated after acid intercalation, without an intermediate water washing step, 5 pph of intercalant is generally sufficient to provide a final expansion volume of 25 to 30 cm³/g.

It will be appreciated that a combination of the low temperature and non-stoichiometric methods may be used, i.e., using a less than stoichiometric amount of acid intercalant and a temperature which is lower than conventionally used.

Graphite starting materials suitable for use in the present invention include highly graphitic carbonaceous materials capable of intercalating organic and inorganic acids as well as halogens and then expanding when exposed to heat. These highly graphitic carbonaceous materials most preferably have a degree of graphitization of about 1.0. As used in this disclosure, the term “degree of graphitization” refers to the value g according to the formula:

$$g = \frac{3.45 - d ( 002 )}{0.095}$$

where d(002) is the spacing between the graphitic layers of the carbons in the crystal structure, measured in Angstroms. The spacing d between graphite layers is measured by standard X-ray diffraction techniques. The positions of diffraction peaks corresponding to the (002), (004) and (006) Miller Indices are measured, and standard least-squares techniques are employed to derive spacing which minimizes the total error for all of these peaks. Examples of highly graphitic carbonaceous materials include natural graphites from various sources, kish graphites, as well as other carbonaceous materials such as carbons prepared by chemical vapor deposition and the like. Natural graphite is most preferred.

The graphite starting materials used in the present invention may contain non-carbon components so long as the crystal structure of the starting materials maintains the required degree of graphitization and they are capable of exfoliation. Generally, any carbon-containing material, the crystal structure of which possesses the required degree of graphitization and which can be exfoliated, is suitable for use with the present invention. Such graphite preferably has an ash content of less than twenty weight percent. More preferably, the graphite employed for the present invention will have a purity of at least about 94%. In the most preferred embodiment, the graphite employed will have a purity of at least about 98%.

Except as otherwise noted, the method for manufacturing the partially expanded graphite flake is preferably as described by Shane et al. in U.S. Pat. No. 3,404,061. In the typical practice of the Shane et al. method, natural graphite flakes are intercalated by dispersing the flakes in a solution containing e.g., a mixture of nitric and sulfuric acid, advantageously at a level of about 20 to about 300 parts by weight of intercalation solution per 100 parts by weight of graphite flakes (pph). The intercalation solution contains oxidizing and other intercalating agents known in the art. Examples include those containing oxidizing agents and oxidizing mixtures, such as solutions containing nitric acid, potassium chlorate, chromic acid, potassium permanganate, potassium chromate, potassium dichromate, perchloric acid, and the like, or mixtures, such as for example, concentrated nitric acid and chlorate, chromic acid and phosphoric acid, sulfuric acid and nitric acid, or mixtures of a strong organic acid, e.g., trifluoroacetic acid, and a strong oxidizing agent soluble in the organic acid. Alternatively, an electric potential can be used to bring about oxidation of the graphite. Chemical species that can be introduced into the graphite crystal using electrolytic oxidation include sulfuric acid as well as other acids.

In a preferred embodiment, the intercalating agent is a solution of a mixture of sulfuric acid, or sulfuric acid and phosphoric acid, and an oxidizing agent, i.e. nitric acid, perchloric acid, chromic acid, potassium permanganate, hydrogen peroxide, iodic or periodic acids, or the like. Although less preferred, the intercalation solution may contain metal halides such as ferric chloride, and ferric chloride mixed with sulfuric acid, or a halide, such as bromine.

For the low temperature process, the quantity of intercalation solution may range from about 20 to about 150 pph and more typically about 50 to about 120 pph. For the non-stoichiometric process, the quantity of intercalation solution may range from about 5 to about 50 pph and more preferably, from about 10 to about 40 pph.

After the flakes are intercalated, any excess solution is drained from the flakes and the flakes are water-washed. Alternatively, the washing step is eliminated and the intercalated flake is transferred directly to a heated furnace. The quantity of the intercalation solution needed to achieve a desired expansion volume is generally lower when no washing step is employed, i.e., between about 10 and about 50 pph, for the low temperature process, 3-35 pph, more preferably, 3-10 pph for the non-stoichiometric process.

The particles of graphite flake treated with intercalation solution can optionally be contacted, e.g., by blending, with a reducing organic agent selected from alcohols, sugars, aldehydes and esters which are reactive with the surface film of oxidizing intercalating solution at temperatures in the range of 25° C. and 125° C. However, since such reducing agents tend to increase the extent of exfoliation considerably, at any selected temperature, the process is advantageously carried out without the use of reducing agents. Unless otherwise specified herein, the expansion volumes, amounts of intercalant, and the temperatures given are for processes carried out without use of a reducing agent.

Thus, the use of the following reducing agents is preferably avoided, or at least minimized: hexadecanol, octadecanol, 1-octanol, 2-octanol, decylalcohol, 1, 10 decanediol, decylaldehyde, 1-propanol, 1,3 propanediol, ethyleneglycol, polypropylene glycol, dextrose, fructose, lactose, sucrose, potato starch, ethylene glycol monostearate, diethylene glycol dibenzoate, propylene glycol monostearate, glycerol monostearate, dimethyl oxylate, diethyl oxylate, methyl formate, ethyl formate, ascorbic acid and lignin-derived compounds, such as sodium lignosulfate.

An expansion aid is optionally applied prior to, during or immediately after intercalation. Expansion aids are conventionally added to reduce the exfoliation temperature and increased expanded volume (also referred to as “worm volume”). In the present process, however, a high worm volume is not advantageous. Accordingly, if an expansion aid is employed in the present process, the process is adjusted to compensate for the effect of the expansion aid on worm volume. Thus, in the case of the low temperature process, an effective exfoliation temperature may be 200-500° C. where no expansion aid is employed. This temperature is preferably reduced by 50-100° C., or more, when an expansion aid is used. Unless otherwise specified elsewhere, the expansion volumes, amounts of intercalant, and the temperatures given are for processes carried out without use of an expansion aid.

In the non-stoichiometric process, the effects of the expansion aid may be compensated for by using even lesser amounts of the intercalant than those specified above. There may be advantages in using an expansion aid in the non-stoichiometric process to allow a lower exfoliation temperature to be employed.

Expansion aids in this context are organic materials sufficiently soluble in the intercalation solution to achieve an increase in expansion. More narrowly, organic materials of this type that contain carbon, hydrogen and oxygen, preferably exclusively, may be employed. Carboxylic acids have been found especially effective. A suitable carboxylic acid useful as the expansion aid can be selected from aromatic, aliphatic or cycloaliphatic, straight chain or branched chain, saturated and unsaturated monocarboxylic acids, dicarboxylic acids and polycarboxylic acids which have at least 1 carbon atom, and preferably up to about 15 carbon atoms, which is soluble in the intercalation solution in amounts effective to provide a measurable increase of one or more aspects of exfoliation. Suitable organic solvents can be employed to improve solubility of an organic expansion aid in the intercalation solution.

Representative examples of saturated aliphatic carboxylic acids are acids such as those of the formula H(CH₂)ₙCOOH wherein n is a number of from 0 to about 5, including formic, acetic, propionic, butyric, pentanoic, hexanoic, and the like. In place of the carboxylic acids, the anhydrides or reactive carboxylic acid derivatives such as alkyl esters can also be employed. Representative of alkyl esters are methyl formate and ethyl formate. Sulfuric acid, nitric acid and other known aqueous intercalants have the ability to decompose formic acid, ultimately to water and carbon dioxide. Because of this, formic acid and other sensitive expansion aids are advantageously contacted with the graphite flake prior to immersion of the flake in aqueous intercalant. Representative of dicarboxylic acids are aliphatic dicarboxylic acids having 2-12 carbon atoms, in particular oxalic acid, fumaric acid, malonic acid, maleic acid, succinic acid, glutaric acid, adipic acid, 1,5-pentanedicarboxylic acid, 1,6-hexanedicarboxylic acid, 1,10-decanedicarboxylic acid, cyclohexane-1,4-dicarboxylic acid and aromatic dicarboxylic acids such as phthalic acid or terephthalic acid. Representative of alkyl esters are dimethyl oxylate and diethyl oxylate. Representative of cycloaliphatic acids is cyclohexane carboxylic acid and of aromatic carboxylic acids are benzoic acid, naphthoic acid, anthranilic acid, p-aminobenzoic acid, salicylic acid, o-, m- and p-tolyl acids, methoxy and ethoxybenzoic acids, acetoacetamidobenzoic acids and, acetamidobenzoic acids, phenylacetic acid and naphthoic acids. Representative of hydroxy aromatic acids are hydroxybenzoic acid, 3-hydroxy-1-naphthoic acid, 3-hydroxy-2-naphthoic acid, 4-hydroxy-2-naphthoic acid, 5-hydroxy-1-naphthoic acid, 5-hydroxy-2-naphthoic acid, 6-hydroxy-2-naphthoic acid and 7-hydroxy-2-naphthoic acid. Prominent among the polycarboxylic acids is citric acid.

The aqueous intercalation solution optionally contains an amount of expansion aid of from about 1 to 10%. In the embodiment wherein the expansion aid is contacted with the graphite flake prior to or after immersing in the aqueous intercalation solution, the expansion aid can be admixed with the graphite by suitable means, such as a V-blender, typically in an amount of from about 0.2% to about 10% by weight of the graphite flake.

More preferably, the intercalation solution, and indeed the entire process, is free or substantially free of both reducing agents and expansion aids. By “substantially free,” it is meant that no more than a total of 0.05% by weight of reducing agents and expansion aids are employed in the intercalation solution, or if added directly to the flake, it is used in no more than an amount of 0.1% by weight of the graphite flake.

After intercalating the graphite flake, it is exposed to temperatures in the range of 25° to 125° C. to reduce the moisture content of the intercalated flake. The heating period is up to about 20 hours, with shorter heating periods, e.g., at least about 10 minutes, for higher temperatures in the above-noted range. Times of one half hour or less, e.g., on the order of 10 to 25 minutes, can be employed at the higher temperatures.

The thus treated particles of intercalated graphite are then exposed to an exfoliation temperature of at or above the intumescent temperature. In the case of the low temperature process, the temperature selected depends on the desired density of the partially expanded particles and whether or not an expansion aid or reducing agent is used. Above the intumescent temperature, the degree of exfoliation is dependent on the temperature and, to a lesser degree, the time of exposure. Thus, where the graphite is not treated with a reducing agent or a expansion aid, an exposure of a few seconds at a temperature of less than about 400° C. is preferred, more preferably, about 300° C. If a reducing agent or expansion aid is used, the temperature and/or exposure time my need to be reduced considerably to achieve the same level of exfoliation.

Another factor which affects the degree of exfoliation is the original particle size of the graphite flake. As the particle size decreases, the level of exfoliation in terms of the density of the exfoliated particles expressed in volume/unit weight, is less. The conditions exemplified above are for +50 mesh graphite particles (by which is meant that at least about 80% of the particles do not pass through a 50 US mesh screen), having a mean particle size of 300 microns or greater. For smaller particles, therefore, the processing variables are adjusted accordingly. For example, where an optimal temperature in the low temperature process is 300° C. for 50 mesh particles, the same level of exfoliation may be achieved with 150 or 200 mesh flake by raising the exfoliation temperature. Unless otherwise stated herein, the process conditions and results are for +50 mesh flake.

In the case of the non-stoichiometric process, the intercalated flake is exposed to a high temperature, e.g., temperatures of about 700° C. to 1000° C., or higher. As with the low temperature process, these temperatures are reduced if a reducing agent or expansion aid is used. Temperatures as low as 160° C. may be needed to compensate for the effects of the expansion aid. Where smaller mesh graphite particles are used, the ratio of acid to graphite may be higher than for larger particles to achieve a similar level of exfoliation.

During the heating step, the particles of intercalated graphite expand much less than is generally the case. Instead of expanding to about 80 to 1000 or more times their original volume, the partially expanded graphite particles produced by both low temperature and non-stoichiometric processes have a volume which is preferably only about 2 to 20 times the original volume.

A preferred low temperature process proceeds as follows: particles of graphite flake are intercalated with a solution comprising nitric acid at a concentration of about 5-10% by weight, and sulfuric acid, at a concentration of about 70-90% by weight, without reducing agents or exfoliation aids in a ratio of about 70-100 pph intercalation solution to 100 parts flake. The intercalated flake is then washed in water. The washed particles are dried in an oven at a temperature below the intumescent temperature (e.g., about 100° C.), for about 20 minutes to 1 hour to reduce the water content to less than 5% by weight. The particles are then placed in a furnace at 300-400° C. for 20-30 minutes, or longer at lower temperatures, to achieve an expansion volume of 10-30 cm³/g.

A preferred non-stoichiometric process proceeds as follows: particles of graphite flake are intercalated with a solution comprising nitric acid, at a concentration of about 5-10% by weight, and sulfuric acid, at a concentration of about 70-90% by weight, without reducing agents or exfoliation aids in a ratio of about 10-40 pph intercalant to 100 parts flake. The intercalated flake is then washed in water. The washed particles are dried in an oven at a temperature below the intumescent temperature (e.g., about 100° C.), for about 20 minutes to 1 hour to reduce the water content to less than 5% by weight. The particles are then placed in a furnace at about 800° C. for about 10 seconds, or less, to achieve an expansion volume of 10-30 cm³/g.

As with the high volume particles conventionally produced, the partially expanded graphite flake results from expansion of the intercalated flake in an accordion-like fashion in the c-direction, i.e., in the direction perpendicular to the crystalline planes of the constituent graphite particles. The expanded, i.e., exfoliated, graphite particles are somewhat vermiform in appearance, like the high volume particles. However, the “worms,” as they are conventionally called, tend to be shorter in length, having a shape that is more like “pillows” than worms. There is thus a greater tendency for the c direction of a pillow to be vertically oriented when the pillows are poured onto a surface. The pillows may be compressed together into flexible sheets which can be formed and cut into various shapes and provided with small transverse openings by deforming mechanical impact. Further, because of their low volume, the pillows can be molded directly into a desired finished shape, such as a gasket or graphite portion thereof. In molding, the pillows are poured into a mold having the shape of the desired final product and compressed.

For molding of the partially expanded graphite, it is advantageous for the pillows to be free flowing. Optimum flow characteristics have been found where the particles have a volume of about 10-25 cm³/g.

For sheet products, flexible graphite sheet and foil are coherent, with good handling strength, and are suitably compressed, e.g., by roll-pressing, to a thickness of about 0.075 mm to 3.75 mm and a typical density of about 0.1 to 1.5 g/cm³. From about 1.5-30% by weight of ceramic additives can be blended with the intercalated graphite flakes as described in U.S. Pat. No. 5,902,762 to provide enhanced resin impregnation in the final flexible graphite product. The additives include ceramic fiber particles having a length of about 0.15 to 1.5 millimeters. The width of the particles is suitably from about 0.04 to 0.004 mm. The ceramic fiber particles are non-reactive and non-adhering to graphite and are stable at temperatures up to about 1100° C., preferably about 1400° C. or higher. Suitable ceramic fiber particles are formed of macerated quartz glass fibers, carbon and graphite fibers, zirconia, boron nitride, silicon carbide and magnesia fibers, naturally occurring mineral fibers such as calcium metasilicate fibers, calcium aluminum silicate fibers, aluminum oxide fibers and the like.

In general, the process of producing flexible, binderless relatively anisotropic graphite sheet material, e.g., web, paper, strip, tape, foil, mat, or the like, comprises compressing or compacting under a predetermined load and in the absence of a binder, the partially expanded graphite particles so as to form a substantially flat, flexible, integrated graphite sheet. The partially expanded graphite particles that generally are pillow-like or vermiform in appearance, once compressed, will maintain the compression set and alignment with the opposed major surfaces of the sheet. The density and thickness of the sheet material can be varied by controlling the degree of compression. The density of the sheet material can be within the range of from about 0.04 g/cm³ to about 2.0 g/cm³. The flexible graphite sheet material exhibits an appreciable degree of anisotropy due to the alignment of graphite particles parallel to the major opposed, parallel surfaces of the sheet, with the degree of anisotropy increasing upon roll pressing of the sheet material to increase orientation. The degree of anisotropy, however, is less than is found in sheets produced from conventional, high volume worms. In roll pressed anisotropic sheet material, the thickness, i.e. the direction perpendicular to the opposed, parallel sheet surfaces comprises the “c” direction and the directions ranging along the length and width, i.e. along or parallel to the opposed, major surfaces comprises the “a” directions and the thermal, electrical and fluid diffusion properties of the sheet are very different, by orders of magnitude, for the “c” and “a” directions.

An application for the partially expanded flake is in the production of electrically or thermally conductive plastics. Such materials have a polymer matrix, such as a polyalkylene, polyvinylchloride, silicone rubber, or polyurethane, in which particles of conductive material are dispersed. The partially expanded graphite flake may be used as the thermally conductive particle alone or in combination with other thermally conductive materials. The improved flow characteristics of the partially expanded graphite allow for more uniform distribution of the particles in the matrix and more uniform conductivity characteristics.

The invention has been described with reference to the preferred embodiment. Obviously, modifications and alterations will occur to others upon reading and understanding the preceding detailed description. It is intended that the invention be construed as including all such modifications and alterations insofar as they come within the scope of the appended claims or the equivalents thereof.

Having thus described the preferred embodiments, the invention is now claimed to be:

1. A method of forming a partially expanded graphite flake material comprising:
a) adding an amount of a liquid intercalation solution to graphite flakes, the liquid intercalation solution including one or members of the group consisting of nitric acid, sulfuric acid, acetic acid, formic acid, potassium chlorate, chromic acid, potassium permanganate, potassium chromate, potassium dichromate, perchloric acid, hydrogen peroxide, iodic acids, periodic acids, ferric chloride, and halides;
b) dispersing the intercalation solution through the graphite flakes to produce intercalated graphite flakes;
c) exfoliating the intercalated graphite flakes to produce the partially expanded graphite flake material having a low volume of no more than 50 cm³/g, the low volume being achieved by controlling at least one of:
a temperature of exfoliation; and
the amount of the liquid intercalation solution.

2. The method of claim 1, wherein the intercalation solution is substantially free of reducing agents and expansion aids.

3. The method of claim 1, wherein step c) includes:
heating the intercalated graphite flakes to a temperature of no more than 500° C.

4. The method of claim 3, wherein step c) includes:
heating the intercalated graphite flakes to a temperature of no more than about 400° C.

5. The method of claim 4, wherein step c) includes:
heating the intercalated graphite flakes to a temperature of about 300° C.

6. The method of claim 1, wherein the graphite flakes are passed directly from step b) to step c) without an intermediate washing step.

7. The method of claim 6, wherein step a) includes:
adding the liquid intercalation solution to graphite flakes in an amount of less than 10 parts by weight of solution per 100 parts by weight of the graphite flakes.

8. The method of claim 7, wherein step a) includes:
adding the liquid intercalation solution to graphite flakes in an amount of about 5 parts by weight of solution per 100 parts by weight of the graphite flakes.

9. The method of claim 1, further including:
prior to step c), washing the intercalated graphite flakes with water.

10. The method of claim 9, wherein step a) includes:
adding the liquid intercalation solution to graphite flakes in an amount of less than about 40 parts by weight of solution per 100 parts by weight of the graphite flakes.

11. The method of claim 10, wherein step a) includes:
adding the liquid intercalation solution to graphite flakes in an amount of 10-35 parts by weight of solution per 100 parts by weight of the graphite flakes.

12. The method of claim 1, wherein the partially expanded flake material has a volume of from 10-25 cm³/g and is free flowing.

13. The method of claim 1, wherein the intercalation solution includes nitric acid and sulfuric acid.

14. A method of forming a sheet material comprising:
compressing the partially expanded graphite flake material of claim 1 to form a flexible sheet.

15. A sheet material formed by compressing the partially expanded graphite flake material of claim 1 to form a flexible sheet.

16. A method of forming a molded product comprising:
compressing the partially expanded graphite flake material of claim 1 in a mold to form the molded product.

17. The method of claim 16, wherein the molded product is a gasket.

18. A molded product formed by compressing the partially expanded graphite flake material of claim 1 in a mold to form the molded product.

19. A method of forming a partially expanded graphite flake material comprising:
a) adding a liquid intercalation solution to graphite flakes, the liquid intercalation solution being substantially free of expansion aids and reducing agents;
b) dispersing the intercalation solution through the intercalated graphite flakes to produce intercalated graphite flakes;
c) exfoliating the intercalated graphite flakes at a temperature of from about 200° C. to about 400° C. to produce the partially expanded graphite flake material which has a volume greater than that of the original graphite flakes.

20. A method of forming a partially expanded graphite flake material comprising:
a) adding a liquid intercalation solution to graphite flakes, the liquid intercalation solution being substantially free of expansion aids and reducing agents;
b) dispersing the intercalation solution through the intercalated graphite flakes to produce intercalated graphite flakes;
c) optionally, washing the intercalated graphite flakes;
d) exfoliating the intercalated graphite flakes to produce the partially expanded graphite flake material which has a volume greater than that of the original graphite flakes, wherein:
when step c) of washing the intercalated graphite flakes is omitted, the liquid intercalation solution is added to the graphite flakes in an amount of 3-10 parts by weight of solution per 100 parts by weight of the graphite flakes; and
when step c) includes washing the intercalated graphite flakes, the liquid intercalation solution is added to the graphite flakes in an amount of 10-35 parts by weight of solution per 100 parts by weight of the graphite flakes.

21. A method of forming a molded product comprising:
intercalating graphite flake with an intercalation solution;
exfoliating the intercalated graphite flake to produce an exfoliated graphite flake having a volume which is greater than that of the original graphite flake and which is less than 50 cm³/g;
introducing the exfoliated flake into a mold;
compressing the exfoliated flake in the mold to form the molded product.
